(19) United States
(12) Patent Application Publication
(10) Pub. No.: US 2024/0101329 A1
(43) Pub. Date: Mar. 28, 2024

(54) PACKAGING FOR ABRASIVE ARTICLES AND METHODS OF USING THE SAME

(71) Applicant: 3M INNOVATIVE PROPERTIES COMPANY, St. Paul, MN (US)

(72) Inventors: Maiken Givot, St. Paul, MN (US); Brett A. Beiermann, St. Paul, MN (US); Melissa C. Schillo-Armstrong, Woodbury, MN (US); Thomas P. Besonen, Shoreview, MN (US)

(21) Appl. No.: 18/261,849

(22) PCT Filed: Jan. 18, 2022
(86) PCT No.: PCT/US2022/012696

§ 371 Date: Jul. 18, 2023

Related U.S. Application Data
(60) Provisional application No. 63/199,702, filed on Jan. 19, 2021.

(51) Int. Cl. B65D 79/02; B65D 43/02; B65D 53/02; B65D 81/20; B65D 81/26; B65D 83/04; B65D 83/08; B65D 85/62; G07F 11/04

(52) U.S. Cl. CPC B65D 79/02; B65D 43/0202; B65D 53/02; B65D 81/2015; B65D 81/2076; B65D 81/268; B65D 83/0409; B65D 83/08; B65D 85/62; G07F 11/04; B65D 65/466

(57) ABSTRACT

A packaging system for abrasive articles that includes a container portion sized to receive the abrasive articles. The system also includes a lid portion that removably couples to the container portion. The system also includes a rechargeable moisture control feature, housed within the packaging system. The rechargeable moisture control feature removes moisture from an atmosphere within the packaging system. The system also includes a moisture indicator that indicates whether moisture is present within the container portion.

### BACKGROUND

Abrasive articles are generally manufactured at a first location, shipped to a distributor at a second location, and then to a customer at a third location where they are utilized. The environmental conditions during the shipment and storage of the abrasive article can negatively affect the performance of the abrasive article. For example, extended storage in humid conditions has been observed to negatively affect the performance of resin bonded abrasive articles, such as cut-off wheels.

Paper packaging, including for example, cardboard, has been used to package a variety of abrasive articles to help contain the abrasive articles and reduce their exposure to environmental conditions. The cardboard packaging allows air and moisture to transfer through and subjects the packaged abrasive article to environmental fluctuations. Shrink wrap has also been used to package a variety of abrasive articles to help reduce packaging costs and reduce exposure to environmental conditions. After wrapping, the shrink wrap allows air and moisture to transfer through the shrink wrap, as well as areas not covered by shrink wrap, and subjects the packaged abrasive article to environmental fluctuations.

### SUMMARY

A packaging system for abrasive articles that includes a container portion sized to receive the abrasive articles. The system also includes a lid portion that removably couples to the container portion. The system also includes a rechargeable moisture control feature, housed within the packaging system. The rechargeable moisture control feature removes moisture from an atmosphere within the packaging system. The system also includes a moisture indicator that indicates whether moisture is present within the container portion.

Systems and methods herein packaging and dispensing solutions for abrasive articles, including bonded abrasive wheels or coated abrasive discs, that address moisture collection concerns and provide increases sustainability through recyclable components and removeable and replaceable moisture capture components. In addition to portable bonded abrasives and coated abrasives, surface conditioning products, including nonwoven products, also show performance degradation in humid environments and benefit from moisture barrier packaging as described in this application.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 illustrates a cutoff wheel.

FIG. 2 illustrates a packaging system for abrasive articles in accordance with an embodiment herein.

FIG. 3 illustrates components of a packaging system for abrasive articles in accordance with embodiments herein.

FIG. 4 illustrates a method of controlling moisture in a packaging system in accordance with embodiments herein.

FIG. 5 illustrates a dispensing system for abrasive articles in accordance with embodiments herein.

FIG. 6 illustrates a method of dispensing abrasive articles in accordance with embodiments herein.

FIG. 7 illustrates a vacuum seal containment system for abrasive articles in accordance with embodiments herein.

### DETAILED DESCRIPTION

There are many types of abrasive articles that are susceptible to performance changes in the presence of moisture, including coated, non-woven and bonded abrasive articles, which may include cut-off wheels, depressed center grinding wheels, cut-and-grind wheels (C&G wheels), flex-wheels, cylindrical grinding wheels (ID/OD/Centerless grinding wheels), surface grinding wheels, plunge grinding, finishing grinding wheels, super-finishing grinding wheels, or polishing grinding wheels.

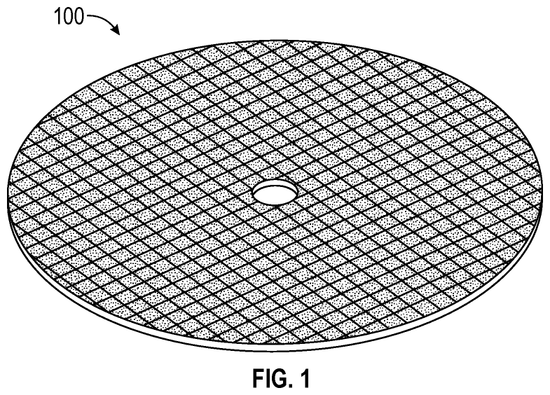

FIG. 1 illustrates a cut-off wheel 100. Cut-off wheels, like other abrasive articles, are often transported from a manufacturing location to a distribution location, and further still to a customer location where they are used.

The shelf life of phenolic resin bond wheels is 3 years, and often a period of 4-6 months passes between manufacture and reaching an end user. Customers expect wheel performance to remain high over the product's lifetime. However, the product performance is considerably reduced once the package is opened, especially when the wheels are exposed to a high humid environment.

This issue is known in the industry, and different solutions have been proposed, including additives to the wheels themselves, coatings on individual wheels, or containers to limit moisture uptake. For example, U.S. Pat. No. 7,661,247, issued on Feb. 16, 2010, discloses a flexible multilayer construction designed with a low water vapor transmission rate or to limit moisture penetration into the packaging solution, while U.S. Pat. No. 10,668,597, issued on Jun. 2, 2020, discloses adding a moisture barrier layer to a nonwoven abrasive article directly.

In addition to addressing moisture adsorption, customers are increasingly concerned about sustainability, particularly recyclability and waste reduction. Multi-material packaging, metal films, and puncture-resistant barriers are often made of non-recyclable materials. It is desired to have a packaging solution that adequately addresses moisture adsorption and is sustainable—e.g. recyclable, reusable, compostable, or otherwise biodegradeable.

Discussed herein are packaging systems and methods that include a moisture control feature and indicator in a rigid container. In some embodiments, to increase sustainability and recyclability of components, the humidity control feature may be rechargeable and/or replaceable. In some embodiments, the packaging system is part of a dispensing system such that a single abrasive article is dispensed at a time.

The moisture vapor transmission rate (MVTR) is a measure of the passage of water vapor through a substance. It is a measure of the permeability for vapor barriers, is determined by the type of material used and the thickness of the material, and is typically tested according to ASTM F1249-01 and/or ASTM D3079.

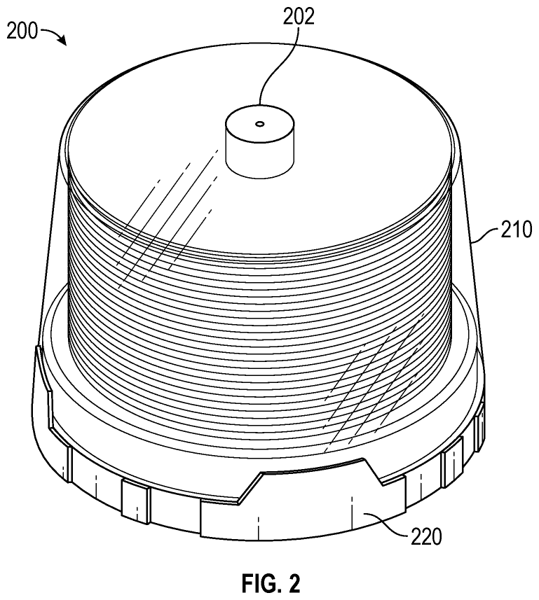

FIG. 2 illustrates a packaging system for bonded abrasive wheels in accordance with an embodiment herein. While systems and methods herein are specifically discussed with regard to bonded abrasive products, it is expressly contemplated that coated abrasive discs or nonwoven abrasive articles may also benefit from or use packaging and dispensing solutions. System 200 is composed of two components, both made from a rigid material. A first component 210 is a transparent component, so that a customer can view abrasive articles stored therein. A second component 220 is received by first component 210. Either first component 210 or second component 220 may have a sealing feature (not shown), such as a compressible component, a foil component, a double-lip component that seals on both sides of a container wall, a rim that provides a sealing area on both a lid and receiving feature or another sealing component that seals the connection between components 210, 220. Additionally, in some embodiments, a feature may be included that pumps out the air, such as turn-and-seal vacuum features used in the food industry to keep coffee or tea fresh.

Component 210 is illustrated in FIG. 2 as having a cylindrical shaped perimeter. However, it is expressly contemplated that, in some embodiments, the perimeter has a different shape, such as a tapered cone. For example, while cylindrical shaped components 210 may match a shape of an abrasive article stored therein, a square, rectangle, hexagon, octagon or other multi-faceted shape may be preferred to prevent container 200 from rolling and/or stack preferentially in supply locations. In other embodiments, a notch, corner, or other stop feature may be present to limit the ability of system 200 from rolling while laying sideways.

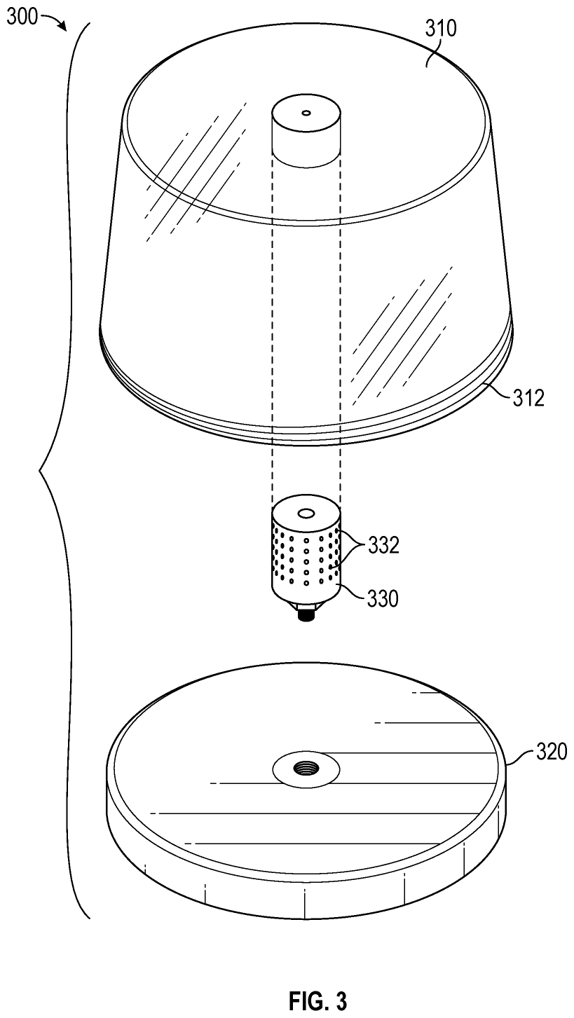

As illustrated in FIG. 2, in some embodiments, component 220 is non-transparent. However, it is expressly contemplated that either component 210 and/or 220 may be transparent, or both may be non-transparent. Transparency of at least one of components 210, 220 may allow for a moisture indicator (not shown in FIG. 2), to be visible to a consumer, as discussed in greater detail with respect to FIG. 3 below.

FIG. 3 illustrates components of a packaging system for bonded wheels in accordance with embodiments herein. However, some embodiments discussed herein may also be suitable for coated abrasive discs and/or nonwoven abrasive articles.

System 300 includes rigid packaging components 310, 320 that releasably couple together, for example through threads, snaps, ribbed or flared seals, multi-material seals (e.g. metal or plastic with a flexible silicone ring), a pump seal, partial threading, twist locks, replaceable moisture seals, or another suitable locking mechanism. One of components 310, 320 is transparent, allowing a customer to view abrasive articles stored inside, as well as a moisture control feature 330. In the illustrated embodiment of FIG. 3, moisture control feature 330 extends perpendicularly from component 320. Moisture control feature 330 may, in other embodiments, be incorporated into either component 310, 320. However, positioning moisture control feature 330 as illustrated in FIG. 3 may allow for abrasive discs to fit over moisture control feature 330, helping retain abrasive discs organized within container 300.

Components 310, 320 may releasably couple together using a coupling feature 322 that, in some embodiments, provides a partial seal to keep moisture out of container 300. Coupling feature 322 is illustrated as threading, but may be any suitable coupling feature. Component 310 may have a corresponding coupling feature 312.

Moisture control feature 330, in one embodiment, holds a moisture adsorbing material 332. In other embodiments, moisture control feature 330 is made of a moisture adsorbing material 332. Moisture control feature 330 and/or material 332 may include a hygroscopic material including desiccant, a clay, a molecular sieve or a zeolite, or another suitable moisture adsorbing material.

Desiccants are commonly used to keep products dry and stable. Dry desiccants can absorb moisture from air either by physical adsorption or by chemical reaction, and thus reduce the humidity in the headspace of sealed containers. Moisture sorption by silica gel is an example of physical adsorption, and sorption by calcium oxide is an example of a chemical reaction. The most commonly used desiccants for solid pharmaceutical products are silica gel, clay, and molecular sieves. The moisture control feature 330 and/or 332 may also include silica powder, activated charcoal, calcium sulfate, calcium chloride.

Silica gel is an amorphous form of silica and is highly porous. Silica gel particles are composed of an interconnecting network of microscopic pores (capillaries), and therefore have a very large surface area. The mechanisms of moisture adsorption by silica gel include surface adsorption and capillary condensation in the porous network. Silica gel works well at ambient temperature, but may have decreased adsorption rate and equilibrium moisture content at higher temperatures. The moisture in silica gel can be removed by drying at a temperature greater than 110° C. The current USP Chapter <671> recommends predrying silica gel desiccant at approximately 150° C. to ensure the complete removal of adsorbed water.

Clay is a low cost and efficient desiccant at low temperature. The primary chemical composition of clay includes silica and aluminum oxide, magnesium oxide, calcium oxide, and ferric oxide. Moisture adsorption capacity may be different for different grades of clay desiccant. Therefore, their moisture adsorption isotherms must be verified during the desiccant selection process. Clay works well at ambient temperature, but at temperatures >50° C., it will likely lose moisture rather than absorb moisture. Clay can be dried at a temperature greater than 110° C.

A molecular sieve is a highly porous crystalline material with precise mono-dispersed pores into which certain sizes of molecules can fit, and thus, it can be used to separate one type of molecule from others. These pores are the channels in the crystalline structure of a material such as zeolite. The pore sizes of molecular sieves differ from silica gel, in that the pore size of a molecular sieve is small and precise, while that of silica gel is much larger with a broad distribution. Molecular sieves are available with different effective pore sizes, such as 3, 4, 5, and 10 Å. A molecular sieve with a 3 Å effective pore size can selectively adsorb water molecules, since the diameter of water molecule is approximately 3 Å, while a molecular sieve with 4 Å pore size can also adsorb nitrogen and oxygen, in addition to water. Molecular sieve desiccants have a very strong affinity and a high adsorptive capacity for water in an environment of low water concentration. At 25° C./10% RH, molecular sieves can adsorb water to approximately 14% of their own weight. This property makes it possible to create an extremely low humidity environment with a small amount of material. Another suitable material may be calcium sulfate, which changes color in the presence of cobalt chloride.

A desiccant is an adsorbent (not an absorbent), that is, it attracts water molecules, which adhere to its surface. Unlike absorbents, which change their volume as they take on the water, desiccants do not change their volume. Commonly available desiccants can hold up to a maximum 35% of their weight in moisture before losing their effectiveness. They work by trapping the moisture while it is still in a water vapor form, before it can condense (become liquid) and cause damage. Desiccants can also absorb water in liquid form.

Moisture control material 332, in some embodiments, provides a visual indication when it has reached, or is nearing, an adsorbing limit. For example, a desiccant such as silica gel, calcium chloride or another suitable material may be mixed with cobalt chloride, which is blue in dry conditions and turns pink when moisture is adsorbed. Additionally, orange silica gel, which turns orange in the presence of water, is a non-toxic, pollution free desiccant that meets the needs of many environmentally-conscious end users. Moisture control feature 330 may then be reusable in that it can be removed from system 300, dried in an oven to remove adsorbed water, and reused.

However, heavy metals present environmental concerns and it is desired to find materials that present less environmental risk. For example, Japanese Patent Application with Publication JP2004331855 Å discloses a polyolefin resin in combination with zeolites, which changes color to clear yellow after moisture absorption.

However, while it may be advantageous for the adsorbing material 332 to change color, it is also expressly contemplated that moisture control feature 330 may indicate the presence of moisture using another moisture indicator known in the art. The moisture indicator may be positioned such that it is visible through a transparent portion of component 310 or 320.

Components 310, 320 are, in some embodiments, made from a sustainable and/or recyclable material. In some embodiments, component 310 is a first material and component 320 is a second material. The first and second materials may be metal, including tin, aluminum, stainless steel, copper, metal alloys; plastic, including bio-based thermoplastic (PLA or PBS), polyethylene, polypropylene, homo or copolymer cast polypropylene, PET, oPET, PTT, low-density polyethylene, high-density polyethylene, polyvinyl chloride, polycarbonate, ethyl-vinyl alcohol, polyvinyl alcohol, PVOH-acrylic coated PET, PVdC-coated PET, metallized PET, polyacrylonitrile, PCTFE, or cyclic olefin copolymer; a flexible material, such as silicone or rubber; or another suitable material. First and second materials may be rigid or may have some flexibility This can be done, for example, by selecting appropriate materials for components 310, 320, adding a moisture adsorbing or absorbing material, or using another moisture removal technique, such as evacuating the container.

In some embodiments, the container has an MVTR of less than 1.0 g/m²/day, or less than 0.9 g/m²/day, or less than 0.8 g/m²/day, or less than 0.7 g/m²/day or less than 0.65 g/m²/day.

A seal may be present between or around components 310, 320. The seal may be re-sealable or may be a one-time seal that is intended to reduce moisture transportation only until a customer opens system 300 for a first time. The seal may be a heat seal, film seal, a clamping lid, compressible threading, or another suitable sealing mechanism.

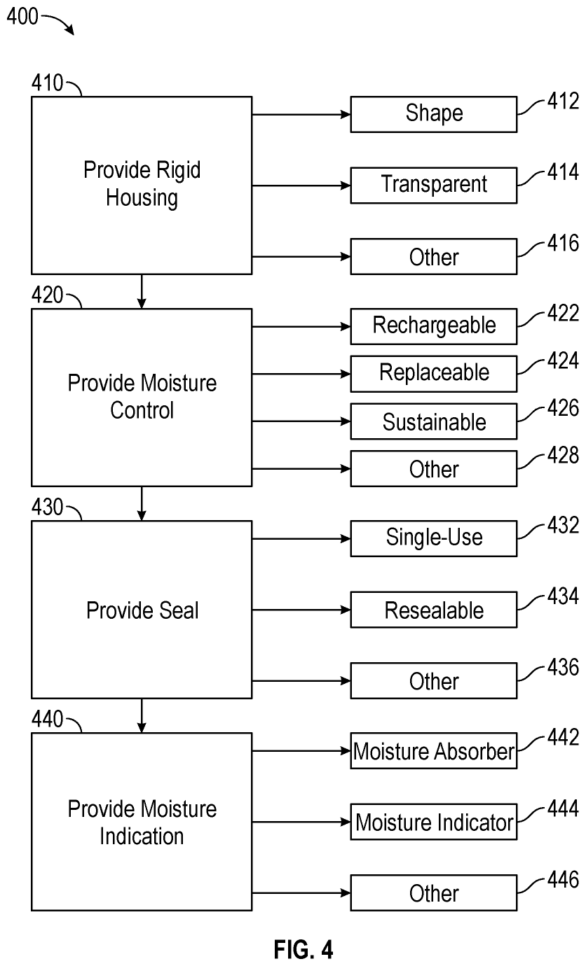

A suitable seal is resistant to moisture and properly sealed to the container components 310 or 320 or both. As illustrated in the Examples below, Example 4 illustrates a film that satisfies these requirements. A tie-layer may be used to ensure attachment of the film to a container. FIG. 4 illustrates a method of controlling moisture in a packaging system in accordance with embodiments herein.

In block 410, a rigid housing is provided for an abrasive articles. In some embodiments, a single housing contains multiple abrasive articles. The rigid housing has a shape 412, for example a cylindrical shape, a tapered shape such as a tapered cylindrical shape, a cube shape, an ovular shape, a rectangular prism shape, or another suitable shape. The shape may also include a stacking feature, such as a protrusion and/or recess to allow a first housing to stack on top of a second housing.

The provided rigid housing may also have a portion that is transparent 414. For example, the housing may include a base portion, which holds the abrasive article, and a lid portion, which seals the base portion closed, and either the base and/or the lid portions may be made from transparent material. For example, the transparent material may be a plastic, glass, or another transparent material. In some embodiments, an additional sealing element, such as a film, provides a sealing function.

The rigid housing may include other features 416. For example, a housing having multiple portions may also include a single-use seal or a resealable feature, such as threading, clamps, snaps or other closures.

The rigid housing, in some embodiments, includes components that are recyclable. In some embodiments, every component of the housing is recyclable. However, in some embodiments, only a subset of the housing is recyclable. For example, a lid and a container portion may be recyclable, and an exterior wrapping may not be. Some example materials that meet sustainability and/or recyclability requirements include biobased materials, including fiber-based material, recycled material, recyclable material, reusable material, compostable materials, or combinations thereof. For example, a reusable plastic container may be wrapped with a recyclable plastic or paper wrapper.

In block 420, a moisture control feature is provided. The moisture control feature may be built into another component, for example a lid may include the moisture control feature, or a container body may include the moisture control feature. The moisture control feature may also be a separate component that is housed within the rigid housing. The moisture control feature may be removably coupleable to either a container body or a lid, in some embodiments. The moisture control feature may also be freely housed within the rigid housing, such that it can move within the housing.

In some embodiments, the moisture control feature is a rechargeable component 422, such that, when it has adsorbed or absorbed water to its full capacity, can be returned to a water adsorbing or absorbing state. For example, a reversible water adsorber can be dried in an oven to remove adsorbed water.

In some embodiments, the moisture control feature is a replaceable feature 424, such that it can be removed from the rigid housing. For example, a used moisture control feature may be removed, recharged, and replaced into the same, or a different, container. In some embodiments, threading of the moisture control feature does not penetrate the container.

In some embodiments, the moisture control feature may be made from a sustainable material 426, for example free of heavy metals. Additionally, some or all of the moisture control feature may made from recyclable materials. The moisture control feature may have other features 428 as well.

In block 430, a seal is provided. The seal may help to prevent or reduce moisture transmission through an area where two or more housing components meet. For example, threading between components may have some spacing that allows for moisture from a humid environment outside of the container. To reduce the opportunity for moisture to enter through the threading, a seal may be added. For example, the seal may be a single-use seal 432, such as plastic shrinkwrap around the two components and spanning the threading that, when broken, cannot be reapplied. In another example, the seal may be a foil seal 210 applied after the container is filled with abrasive articles but before a cover is provided. The seal could be a metal lid opened outward, such as a ring, or inward, like a pop can.

The seal may also be a resealable seal 434. For example, threading on housing components may be sized such that gaps are not present. Additionally, or alternatively, threading may be made of a material with some compressibility, such that air cannot flow through. The seal may have a hinged lid, or may be a plastic seal with one or two lips that couple along a sealing area of a housing component.

The seal may also have other features 436, for example tamper evidence or other features.

In block 440, a moisture indication is provided. The moisture indication may be provided by a material 442 for the moisture control feature that adsorbs water from the atmosphere. For example, the moisture adsorbing material may contain a certain amount of a color-changing material that changes from a first color when it can adsorb more water, and a second color when it is nearing or has reached a capacity for water adsorption. Alternatively, in some embodiments, the moisture indicator is a separate indicator that indicates a moisture level above a certain threshold, for example indicating that the moisture control feature is exhausted.

Some or all components of the housing may be recyclable, for example a recyclable plastic, a metal, a glass component, a formed fiber or pulp component, with or without a protective moisture laminate layer; water resistant cardboard, formable paper packaging. Some or all components of the housing may also be made of bio-based and/or biodegradable materials, for example polylactic acid or another suitable material. Sustainable materials may include recyclable materials, such as plastics, metals or other materials that can be recaptured and recycled. Additionally, some embodiments herein include reusable parts with one or more sustainable polymer components, such as bio-based or degradeable polymers or mixtures of polymers. Such materials may be preferred in some embodiments as the polymer mixtures may provide tunable properties, as described in U.S. Provisional Patent Application with Ser. No. 63/074,617, filed on Sep. 4, 2020. In some embodiments, polylactic or polybutylene succinate are used for one or more components.

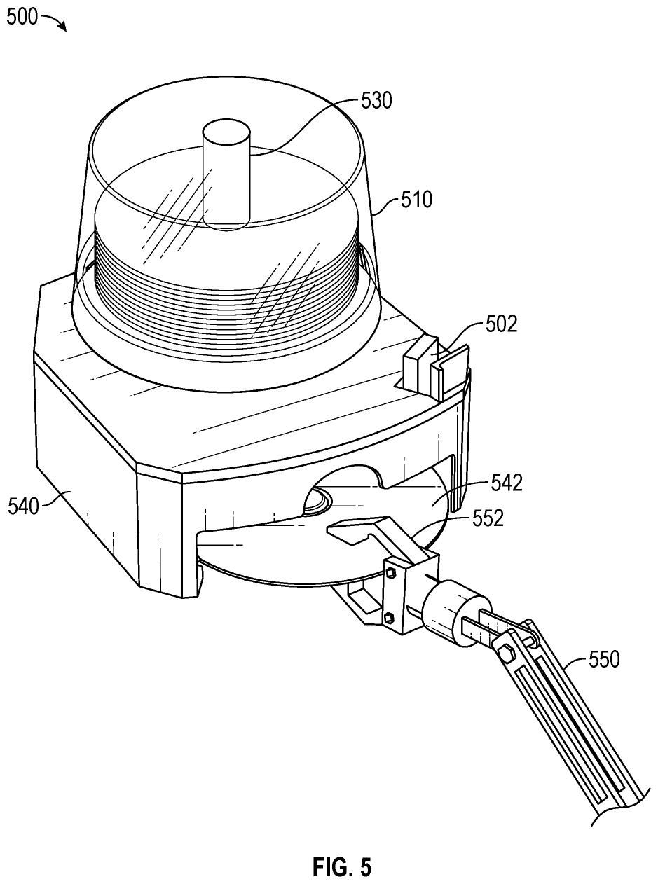

FIG. 5 illustrates a dispensing system for abrasive articles in accordance with embodiments herein. System 500 includes a container 510 that couples to a dispenser 540. Container 510 may removably couple to dispenser 540, in some embodiments, such that dispenser 540 can be reused with a new container 510 full of new abrasive discs. The removeable coupling between container 510 and 540 may include a seal, such as a reusable film seal or another suitable sealing mechanism.

Container 510 includes a moisture control feature 530 that, in one embodiment, extends from a top of container 510 toward dispenser 540. Moisture control feature 530 may be a rechargeable material that adsorbs moisture within the environment inside container 510. Moisture control feature 530 may provide an indication of moisture present inside container 510. The indication may be provided by the material of feature 530 which may, for example, change color as water is adsorbed. Alternatively, the moisture indication may be provided by a separate moisture indicator visible through container 510, for example a humidity indicator card.

Dispenser 540 may dispense a single abrasive disc 542 at a time in such a manner that disc 542 is retrievable by a user or by a robotic arm component 550, using a coupling component 552. Coupling component 552 may be a clamping feature, as illustrated in FIG. 5, or may be another suitable attachment feature, for example an adhesive, a magnet that attaches to a magnetic hub or bushing of abrasive disc 542, or another suitable mechanism. Coupling feature 552 may also include a suction device that operates at sub-atmospheric pressure, for example.

Dispensing each abrasive disc may include an operator manually activating a trigger 502, which may be a spring-loaded button, a key, a switch or another suitable mechanism. Alternatively, dispensing may include receiving a sensor signal or instruction to dispense a disc from a dispenser, or to dispense other equipment. The sensor signal may come from a robotic grinding unit, a timer, or another suitable digital or electronic source.

A dispenser may be designed to accommodate different wheel sizes (e.g. about 3″ (76.2 mm), 4″ (101.6 mm), 4.5″ (114.3 mm), 5″ (127 mm), 6″ (152.4 mm), 7″ (177.8 mm), 9″ (228.6 mm) or other sizes. Optionally an adapter may be designed to adjust the dispenser to different wheel sizes, eg. 4.5″ and 5″ wheel diameter. In some embodiments, the dispenser is made of a sustainable material such as molded paper, a bio-degradable, or compostable material.

A customer may open a shipping/storage container by removing a hermetic sealing film, and engaging it with the dispensing unit. Optionally, a hermetic barrier can be designed into the dispensing unit to reduce moisture to the wheels.

Wheels can now easily be dispensed, neatly stored on a work bench, with visibility of the stocking level at hand. And a moisture control feature provides continued wheel performance even after opening the foil/lid, as it is located furthest from the ‘open’ area.

However, while FIG. 5 illustrates one version of a dispenser, it is expressly envisioned that containers herein may be compatible with other dispensing mechanisms. For example, a vending machine in a high humidity area it is envisioned to pack individual (or small quantities, such as 3-5) abrasive wheels into hermetically sealable clam shell packaging that contains a dessicant layer inside the lid.

The clam shells may have an optional hang tab for placement on sales displays in stores or inside a vending machines.

Once removed from the vending machine, the abrasive wheels can be taken out of the clam shell, and the empty clam shell be returned to a receptical inside or near the vending machine, returned to the distributor and vendor/manufacturer for refilling. This solution provides single or small unit dispensing without additional packaging waste.

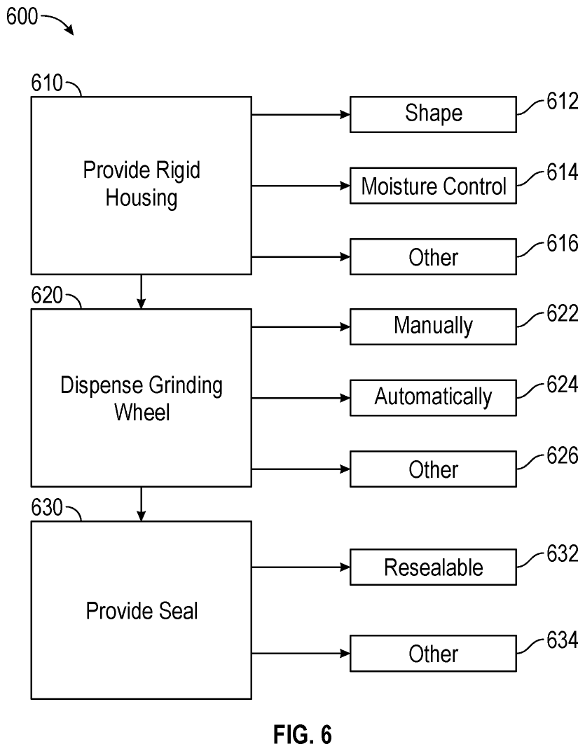

FIG. 6 illustrates a method of dispensing abrasive articles in accordance with embodiments herein. The method illustrated in FIG. 6 may be useful for dispensing abrasive articles to be used by a manual or a robotic operator. Many abrasive operations are increasingly being performed using robotic components. Robotic grinding systems may be able to execute more even grinding patterns and apply a more even force pattern, leading to optimized usage and life of the abrasive tool. However, one problem facing the use of robotic grinding systems is getting abrasive components, particularly moisture sensitive ones, to a robotic arm. A dispenser may be mounted on a robotic arm such that a disc can be dispensed to the robot and then used in an abrasive operation. The robotic arm may be part of a dispensing system that can verify, for example by checking a moisture indicator inside a dispensing system, that the dispensed disc has not been contaminated with moisture. Such a verification may be done using an optic sensor to detect a visual cue, such as a color change of a moisture adsorbing material, or may be able to read an age of a dispensed abrasive disc.

In block 610, a rigid container is coupled to a dispensing system. The rigid container may have a shape 612 that is shaped to receive abrasive articles for dispensing. For example, the shape 612 may have a perimeter that is larger than a circular perimeter of an abrasive disc, such as a larger circle or another polygonal shape, such as a square or rectangle with a corner to prevent the container from rolling.

The rigid container may have a moisture control feature 614. As illustrated in FIG. 5, a moisture control feature 530 my extend from a surface of container 510. However, it is expressly contemplated that a rigid container may be made, at least partially, from a moisture controlling material that either adsorbs or absorbs moisture from the atmosphere within the container. The rigid container may also include other features 616.

In block 620, an abrasive article is dispensed. For example, the abrasive article may be dispensed manually, as indicated in block 622, for example by triggering a dispensing mechanism. A human may trigger the dispensing mechanism, such as by pushing a spring-loaded button, or a robotic arm may trigger the dispensing mechanism, for example by sending a signal or triggering a sensor on the dispenser. Alternatively, the dispensing mechanism may be triggered automatically, as indicated in block 624, for example based on a received signal, a passage of time, or another trigger. Dispensing an abrasive wheel may also include other steps as indicated in block 626, such as dispensing cooling fluid, lubricant, or another grinding aid.

In block 630, a seal is provided. A housing may dispense multiple abrasive articles that it stores. After a first abrasive article is dispensed and before a second abrasive article can suffer prolonged exposure to an atmosphere outside of the container, a seal may be engaged to separate the interior of the container from an exterior atmosphere. The seal may be resealable, as indicated in block 632. The seal may also include other features as in block 634.

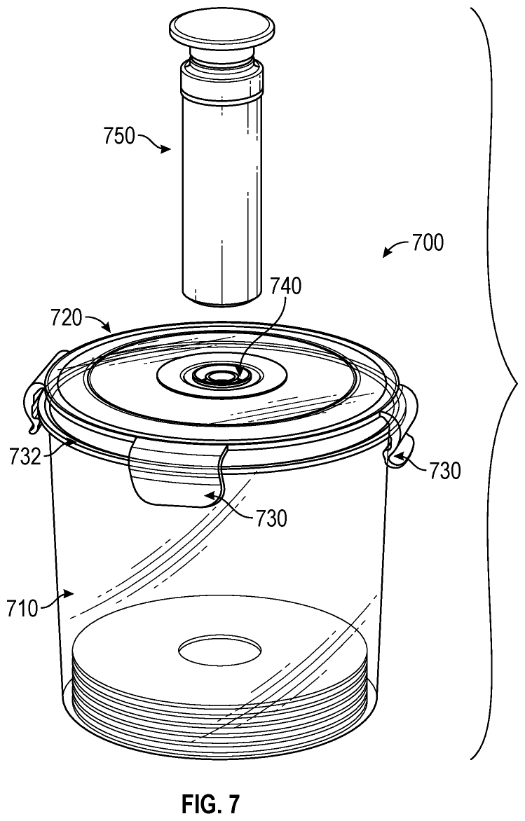

FIG. 7 illustrates a vacuum seal containment system for grinding wheels in accordance with embodiments herein. System 700 includes a canister 710 with a replaceable lid 720. As illustrated in FIG. 7, lid 720 may have one or more clamps 730 that couple it to canister 710, in some embodiments. However, in some embodiments, lid 720 couples to canister 710 using threads, snaps, or another suitable mechanism. In some embodiments, no additional mechanical mechanism 730 is needed as, once a vacuum is applied, it maintains closure. In some embodiments, a sealing feature 732, such as a ring of silicone, rubber, or another suitably compressible material is positioned such that it creates an air-tight seal between canister 710 and lid 720 when they are coupled.

Canister 710 and lid 720 are, in some embodiments, composed of rigid material and are configured to withstand a pressure differential between an exterior pressure and an interior pressure. Lid 720, in some embodiments, may also be a flexible material, such as a film, with a vacuum port 740. Lid 720 includes a vacuum seal 740 that is configured to interact with a vacuum pump 750 such that air can be removed from the container. FIG. 7 illustrates a handheld, manually operated vacuum pump. However, it is expressly envisioned that machine operated pumps may also be used. However, manual pumps 750 may be preferred such that customers can easily open canister 710, remove a disc as needed, replace lid 720 and evacuate air using pump 750.

Canister 710 and lid 720 are composed of materials sufficiently strong to withstand a vacuum. Canister 710 and lid 720 may be the same, or different materials and, in some embodiments, may be selected from glass, plastic or metal.

Sealing feature 740 is composed of a compressible material that allows for pump 750 to access the interior of canister 710 to remove air while substantially maintaining a seal between the interior of canister 710 and the exterior of canister 710. In some embodiments, sealing feature 740 is made of silicone or another deformable polymer, such as silicone rubber, natural rubber, synthetic rubbers, polyolefins, thermoplastic elastomer, fluoropolymer elastomers, polyurethanes, plasticizer-modified engineering polymer, or other deformable material. Sealing feature 740 may also, in some embodiments, be an incompressible material. Sealing feature 740, in one embodiment, comprises an access port that is configured to couple to pump 750 for air evacuation, and reseal to maintain a pressure differential between the interior and exterior of container 710.

Systems and methods described herein concern control of moisture in the atmosphere within a container or dispensing unit prior to use of abrasive articles stored therein. Abrasive articles typically have a known shelf life, and a performance level which may decrease with moisture uptake. The remaining shelf life may be a number of months or years from manufacture. Such a shelf life may be indicated by a batch lot, manufacture date, or a timer placed on a package that indicates to a customer when the product may be past a shelf-life date.

Systems and methods herein provide packaging and dispensing containers for abrasive articles. Containers may be designed to hold a single abrasive article, 10 abrasive articles, 25 abrasive articles, 50 abrasive articles or 100 abrasive articles, or 500 abrasive articles, or 1000 abrasive articles, or more than 1000 abrasive articles, or any suitable number in between. The containers, in some embodiments, have a low water vapor transmission rate to reduce moisture penetration during transport and storage. In some embodiments the container is recyclable or compostable.

A moisture absorbing unit can be placed inside or may be integral to the container. The moisture absorbing unit may be combined with a moisture indicator, showing a customer that the moisture content in the container has been kept low, ensuring desired product quality.

In some embodiments, after filling the container with abrasive products, the container is hermetically (heat or adhesive-) sealed with a moisture barrier film. A protective atmosphere, such as nitrogen or argon may be applied to prevent pre-mature moisture uptake.

Optionally a snap-on cap/lid can be used to secure the product during shipping. The lid design can be such that it provides stackability.

The above-presented description and figures are intended by way of example only and are not intended to limit the illustrative embodiments in any way except as set forth in the appended claims. It is noted that various technical aspects of the various elements of the various exemplary embodiments that have been described above can be combined in numerous other ways, all of which are considered to be within the scope of the disclosure.

Accordingly, although exemplary embodiments have been disclosed for illustrative purposes, those skilled in the art will appreciate that various modifications, additions, and substitutions are possible. Therefore, the disclosure is not limited to the above-described embodiments but may be modified within the scope of appended claims, along with their full scope of equivalents.

A packaging system for abrasive articles that includes a container portion sized to receive the abrasive articles. The system also includes a lid portion that removably couples to the container portion. The system also includes a rechargeable moisture control feature, housed within the packaging system. The rechargeable moisture control feature removes moisture from an atmosphere within the packaging system. The system also includes a moisture indicator that indicates whether moisture is present within the container portion.

The packaging system may be implemented such that the container portion or the lid portion have a transparent area such that the moisture indicator is visible.

The packaging system may be implemented such that it includes a sealing feature between the container portion and the lid portion.

The packaging system may be implemented such that the sealing feature is a reusable sealing feature.

The packaging system may be implemented such that the sealing feature is a single use sealing feature.

The packaging system may be implemented such that the rechargeable moisture feature is a desiccant, a zeolite, a clay, or a molecular sieve.

The packaging system may be implemented such that the rechargeable moisture feature removes moisture through adsorption.

The packaging system may be implemented such that the rechargeable moisture feature removes moisture by absorption.

The packaging system may be implemented such that the moisture indicator indicates whether moisture is present above a threshold concentration.

The packaging system may be implemented such that the moisture indicator indicates that the rechargeable moisture control feature is saturated.

The packaging system may be implemented such that the moisture indicator is a color change of the moisture control feature. The color change indicates that the moisture control feature has reached an adsorption loading capacity.

The packaging system may be implemented such that the moisture indicator is a conductivity indication, indicating that moisture is present at a concentration sufficient for the moisture control feature to conduct electricity.

The packaging system may be implemented such that the container portion or the lid portion include plastic, glass, metal, or shaped fiber pulp.

The packaging system may be implemented such that the plastic is a biobased or recyclable plastic.

The packaging system may be implemented such that the plastic is a biodegradable plastic.

The packaging system may be implemented such that the sealing feature is a film.

The packaging system may be implemented such that the sealing feature is an adhesive.

The packaging system may be implemented such that the sealing feature is integral to the container portion or the lid portion and includes a closure mechanism.

The packaging system may be implemented such that the closure mechanism includes threading or a flange.

The packaging system may be implemented such that a shelf life indicator.

The packaging system may be implemented such that it also includes a sealing feature, positioned on the lid portion. The sealing feature includes an access port for a vacuum pump. The sealing feature is configured to maintain a pressure differential across the lid portion.

The packaging system may be implemented such that it includes a sealing feature, positioned on the container portion. The sealing feature includes an access port for a vacuum pump. The sealing feature is configured to maintain a pressure differential across the container portion.

A method of reducing moisture in an abrasive article during transportation or storage is presented that includes providing a housing with a shape that receives an abrasive article. The housing has a transparent portion. The method also includes providing a moisture control feature, within the packaging housing. The moisture control feature is removably coupled to an interior of the housing. The method also includes providing a seal that reduces moisture transmission into the housing and providing a moisture indication that indicates that the moisture control feature has reached a moisture collection capacity.

The method may be implemented such that the shape is a polygonal shape with a perimeter selected from the group consisting of: a circle, a square, a rectangle, an oval, a pentagon, a hexagon, a heptagon, an octagon, a nonagon, or a decagon.

The method may be implemented such that the transparent portion is a window.

The method may be implemented such that the housing includes a lid portion and a container portion.

The method may be implemented such that the lid portion or the container portion are transparent.

The method may be implemented such that the lid portion and the container portion include metal, glass, plastic or shaped fiber-pump.

The method may be implemented such that the lid portion and the container portion are bio-based, recyclable, reusable or compostable.

The method may be implemented such that the lid portion or the container portion includes a biodegradeable material.

The method may be implemented such that the moisture control feature is rechargeable.

The method may be implemented such that the moisture indication indicates that the moisture control feature has reached an adsorption loading capacity or an absorption limit.

The method may be implemented such that the moisture indication is a color change of the moisture control feature.

The method may be implemented such that the seal is a film seal, an adhesive seal, a flange, or a compressible component.

The method may be implemented such that it also includes flushing the housing with argon or nitrogen gas.

The method may be implemented such that providing the moisture indication includes providing a humidity indicator visible through the transparent portion.

The method may be implemented such that it also includes evacuating the housing.

The method may be implemented such that evacuating includes coupling a vacuum pump to a vacuum sealing feature, and actuating the vacuum pump.

The method may be implemented such that actuating includes manually operating the vacuum pump.

An abrasive article dispensing system is presented that includes a housing with a container portion and a dispenser. The dispenser includes a dispenser coupling feature that releasably couples to the container coupling feature to removably couple the housing to the dispenser, a dispensing mechanism that receives a single abrasive article from the housing container and a trigger that, when initiated, causes the dispensing mechanism to release the abrasive article from the housing.

The abrasive article dispensing system may be implemented such that it includes a resealable closure between the housing and the dispenser that seals a connection between the housing and the dispenser when the dispenser is not actively dispensing the abrasive article.

The dispensing system may be implemented such that the housing includes a moisture control feature within the container portion. The moisture control feature reduces moisture within the container portion. The dispensing system may also include a moisture indicator that indicates a humidity within the container portion and a container coupling feature;

The dispensing system may be implemented such that the container coupling feature and the dispenser coupling feature include corresponding threading.

The dispensing system may be implemented such that the container coupling feature or the dispenser coupling feature includes a clamp.

The dispensing system may be implemented such that the container coupling feature or the dispenser coupling feature includes a flange.

The dispensing system may be implemented such that the dispensing mechanism positions the single abrasive article such that a receiving portion of the abrasive article is retrievable by a robotic device.

The dispensing device may be implemented such that the robotic device includes a suction device.

The dispensing device may be implemented such that the robotic device includes a clamp.

The dispensing system may be implemented such that a metal hub of the abrasive article is available for a magnetic receiver of the robot device to couple to.

The dispensing system may be implemented such that the moisture control feature includes an adsorbing material or an absorbing material.

The dispensing system may be implemented such that the moisture control feature extends from an interior surface of the container portion.

The dispensing system may be implemented such that the moisture control feature fits to an interior surface of the container portion.

The dispensing system may be implemented such that the moisture indicator is a color change of the moisture control feature when an absorbing loading capacity or an adsorbing loading capacity is reached.

The dispensing system may be implemented such that the trigger is a manual trigger.

The dispensing system may be implemented such that the trigger is a signal receiver.

The dispensing system may be implemented such that the trigger is a timer.

The dispensing system may be implemented such that the container portion is bio-based, reusable, compostable or recyclable.

The dispensing system may be implemented such that the container portion includes a biodegradeable material.

The dispensing system may be implemented such that the dispenser is bio-based, reusable, compostable or recyclable.

A method of dispensing abrasive articles is presented that includes providing a rigid housing container containing a moisture control feature, a moisture indicator, a first abrasive article and a second abrasive article. The method also includes removably coupling the rigid housing container to a dispenser. The method also includes when triggered, dispensing the first abrasive article from the rigid housing container through the dispenser. The moisture control feature is a rechargeable moisture control feature/ The rigid housing container is recyclable.

The method may be implemented such that it includes sealing the rigid housing container such that the second abrasive article is sealed from an ambient environment outside of the rigid housing container.

The method may be implemented such that the recyclable rigid housing container includes a metal, glass, a plastic or a shaped fiber-pulp.

The method may be implemented such that the moisture control feature is a desiccant, a clay, a zeolite, or a molecular sieve.

The method may be implemented such that sealing includes a reusable seal.

The method may be implemented such that removably coupling the rigid housing to the dispenser includes threading.

The method may be implemented such that the moisture indicator is a color change of the moisture control feature when an adsorption or absorption limit is reached.

The method may be implemented such that triggering includes a manual release mechanism.

The method may be implemented such that triggering includes receiving a sensor signal.

### EMBODIMENTS

### Embodiment 1

A rigid container made from ABS has a center post that is a re-movable, re-chargeable desiccant container. Containers, such as those sold by Rose-Plastic, have an integrated center post, aligning the discs and protecting the wheel edges from damage.

It is envisioned to make

1) The post out of a material that is filled with a desiccant.

2) The post being designed such that the color of the desiccant is visible to the user.

3) The post being removable from the container, so it can be re-charged at 110-150° C., re-inserted into the base plate and being used for keeping the remaining wheels dry, or drying cut-off wheels being inserted from a flexible pouch into the storage container.

### Embodiment 2

A circular, color-changing, re-chargeable desiccant is placed below cut-off wheels in a container, or above in the form of a film around the inner surface of the container. The container can be composed of metal or a polymer material tolerating the desiccant recharge cycles at 110-150° C.

### Embodiment 3

The system of either Embodiment 1 or Embodiment 2, with a humidity indicator card (HIC) to be provided inside the transparent packaging container or mounted to the inside of a lid.

### Embodiment 4

In addition to the systems of Embodiments 1-3, a QR code, website link, or printed statement is provided to inform customers of the purpose of moisture barrier solutions and engage them to protect the product performance.

### Embodiment 5

Alternatively to adsorbing materials, such as desiccants, it is also envisioned to use absorbants, such as super-absorbing polymers, such as that used in diapers. While they swell, adding them into the center post described in Embodiment 1 or a large enough container, described in Embodiment 2, should provide sufficient space for this solution.

### Embodiment 6

A metal, glass, molded fiber-pulp container (with or without laminate) or plastic container is provided with an internal or external screw-on lid, clamping, magnetic or frictional structures.

### Embodiment 7

Any of the containers of Embodiments 1-6, with a heat-seal or adhesive foil.

### Embodiment 8

The container of Embodiment 7, with a screw-on or snap-on lid.

### Embodiment 9

The container of any of Embodiments 1-8 with a square lid or bottom.

### Embodiment 10

The container of Embodiment 9, where the packaging is a square telescopic plastic packaging tube with a ratchet length adjustment.

### Embodiment 11

The container of Embodiment 10 with a heat-seal or adhesive foil seal.

### Embodiment 12

The container of any of Embodiments 1-11, with a user-activated air-tight seal.

### Embodiment 13

A metal, plastic, glass or molded/shaped fiber-pulp with or without lamination jar/tub with a screw-on or snap-on lid, and a moisture absorbing material (desiccant), such as silica gel, zeolites, bauxite, alumina, anhydrous calcium sulphate, water-absorbing clays, moisture absorbing inorganic salts used in pharmaceuticals, precision or musical instruments, leather goods, or dry foods.

For example, a desiccant and a pre-polymerized polyurethane resin being cast into a shape or film that allows for mounting inside the storage container.

Typical MVTR of polyurethane resins (2-6 mils) range from 40-100 g/100 in 2/24 h at 100 F (U.S. Pat. No. 4,036,360 to Deffeyes).

a) The desiccant can be cast into the shape of the container bottom such that it fills reservoirs provided by the shape (e.g. recesses found at the bottom of soda bottles). The wheels can then be placed on top of the desiccant layer.

Using a transparent container material allows for visualizing if the moisture level in the container exceeds the threshold at which performance drop is to be expected (as well how many wheels are still in the container). A removable desiccant insert is of advantage for end users, such that they can dry the desiccant once it has reached the moisture threshold, indicated by a color change, and re-use it.

A color change indicates if moisture exceeds level at which product performance is compromised. A customer can be informed via graphics or QR codes how to solve this issue (heating wheels and/or desiccant to remove the moisture).

b) The desiccant and a pre-polymerized polyurethane resin can be cast into a shape or film that allows for mounting inside the storage container lid, which is a jar with a sealing film and screw-on lid. The lid is made of a transparent material, or has a clear insert/window, allowing the visualization of humidity caused color change of the desiccant ‘pad’ mounted to the inside of the lid.

c) The container includes a moisture absorption indicator as described in U.S. Pat. No. 8,268,421 B2, including a light reflective or light absorbing film and a pattern printed layer, including a moisture absorption indicator pattern, and a desiccant containing resin film that becomes transparent due to moisture absorption, can be placed inside the transparent lid (or transparent bottom portion of the container), indicating the moisture content after the package has been opened.

Such a design allows the wheels to stay moisture protected during transport. Once the container is opened and the sealing film removed, the desiccant can protect the wheels in the now ‘opened’ container from moisture uptake.

### Embodiment 14

The container of any of Embodiments 1-13, which undergoes a dry nitrogen or argon flushing prior to sealing the storage container.

### Embodiment 15

Any of the above, with a vacuum seal.

### EXAMPLES

Unless otherwise noted, all parts, percentages, ratios, etc. in the Examples and the rest of the specification are by weight; and wt. % means weight percent. Table 1, below, reports materials used in the Examples.

In Comparative Examples H through N of patent copending U.S. Provisional Patent Application 63/190,595, filed May 19, 2021, it was seen that rigid containers did not provide moisture protection necessary for cut-off wheels. The following examples will showcase the use of films on rigid containers and learnings needed to make the system moisture protecting.

TABLE 1

| ACRONYM | DESCRIPTION AND SOURCE | COMMENTS |
|---|---|---|
| COW | 3M CUBII COW 41 125 × 1 × 22, 23 mm | Cut-off wheels |
| | PN65512 from 3M Corporation | |
| FB1 | Multilayer barrier film bag outside dimensions 210 × | Foil bag |
| | 260 MM from AKAT GROUP Sp. Z. O. O. in Swieta | |
| | Katarzyna, Poland | |
| FF1 | CFlex paper bag | Flexible Film |
| FF2 | CFlex Al 38 | Flexible Film |
| FF3 | CFlex PE film | Flexible Film |
| FF4 | Press N Seal | Flexible film |
| ML-B1 | Multilayer metalized PET barrier film with aluminosilicate | Multilayer |
| | layer sandwiched between polymerized acrylic layer made | barrier film |
| | as described in EXAMPLE 2 of 83817US002 | |
| ML-B2 | Multilayer transparent PET barrier film with aluminosilicate | Multilayer |
| | layer sandwiched between polymerized acrylic layer made | barrier film |
| | as described in EXAMPLE 1 or 83817US002 | |
| RC | Rapid prototyped container built 40 mm height, 135 mm OD | Rigid |
| | and 10 mm wall thickness were made by 3D printing using | container |
| | material Accura 25 | |

Cut-off wheels were held in various conditions with and without packaging according to the examples. Performance of the wheel was quantified by a cutting test method as described below.

### Cutting Test Method

A 40-inch (1 m) long sheet of 0.12 inch (3 mm) thick stainless steel was secured with its major surface inclined at a 35-degree angle relative to horizontal. A guide rail was secured along the downward-sloping top surface of the inclined sheet. A DeWalt Model DWE43114N 4.5-inch (11.4-cm)/5-inch (12.7-cm) cut-off wheel angle grinder was secured to the guide rail such that the tool was guided in a downward path under the force of gravity. A cut-off wheel for evaluation was mounted on the tool such that the cut-off wheel encountered the full thickness of the stainless steel sheet when the cut-off wheel tool was released to traverse downward, along the rail under gravitational force. The cut-off wheel tool was activated to rotate the cut-off wheel at 10000 rpm, the tool was released to begin its descent, and the length of the resulting cut in the stainless steel sheet was measured after 60 seconds. Dimensions of the cut-off wheel were measured before and after the cutting test to determine wear. Wear rate [mm3/min] is the rate of volume removal of the wheel as it cuts.

### Pre-Conditioning

Two hundred COW were removed from all packaging materials and conditioned in an oven at 130° C. for 24 hours. Further use of these heat-treated wheels refers to them as “pre-conditioned”. Three wheels were tested immediately after pre-conditioning (Day 0) by the cutting test method to provide a baseline of wear rate performance for the other samples in the packaging study.

### Rigid Containers

Seven rigid cylindrical containers (RC) with 40 mm height, 135 mm OD and 10 mm wall thickness were made by 3D printing using material Accura 25.

### Comparative Example A

Fifteen (15) pre-conditioned COW were placed in a low humidity storage unit (XD-302 dry 25 cabinet made by XDry (Anna, Texas) at 5.0% R/H and ambient temperature). Three wheels were removed from the storage unit after 7 days. The wheels were post-conditioned at 65° C. for 2 hours. The wheels were tested by the cutting test method. Four wheels each were removed from the storage unit after intervals of 14, 21, and 42 days. The wheels were post-conditioned at 65° C. for 2 hours. The wheels were tested by the cutting test method.

### Comparative Example B

Fifteen (15) pre-conditioned COW were placed in an environmental chamber at 90% RH and 90° F. (32° C.). Three wheels were removed from the storage unit after 7 days. The wheels were post-conditioned at 65° C. for 2 hours. The wheels were tested by the cutting test method. Four wheels each were removed from the storage unit after intervals of 14, 21, and 42 days. The wheels were post-conditioned at 65° C. for 2 hours. The wheels were tested by the cutting test method.

### Comparative Example C

Comparative Example B was repeated except that prior to placing the pre-conditioned wheels in the environmental chamber, they were packaged in FB1. The FB1 bag was sealed by Ziplock and heat-sealed at with a Sunbeam Iron (Model #3951-083) on the Cotton heat setting for approximately 3 seconds. The ML-FB bag was resealed after each use.

### Comparative Example D

Comparative Example C was repeated except that the wheels were packaged in FF1. FF1 was sealed into a pouch by Sunbeam Iron (Model #3951-083) on the Cotton heat setting for approximately 3 seconds.

### Comparative Example E

Comparative Example C was repeated except that the wheels were packaged in FF2. FF2 was sealed into a pouch by Sunbeam Iron (Model #3951-083) on the Cotton heat setting for approximately 3 seconds.

### Comparative Example F

Comparative Example C was repeated except that the wheels were packaged in FF3. FF3 was sealed into a pouch by Sunbeam Iron (Model #3951-083) on the heat setting between acetate/nylon & acrylic/silk for approximately 2 seconds.

### Example 1

Comparative Example B was repeated except that prior to placing the pre-conditioned wheels in the environmental chamber, they were placed in RC. A piece of FF3 was attached to the opening of RC by Sunbeam Iron (Model #3951-083) on the heat setting between acetate/nylon & acrylic/silk for approximately 2 seconds.

### Example 2

Example 1 was repeated except that the film attached to RC was FF1. FF1 was attached to RC by Sunbeam Iron (Model #3951-083) on the Cotton heat setting for approximately 3 seconds.

### Example 3

Example 1 was repeated except that the film attached to RC was FF2. FF2 was attached to RC by Sunbeam Iron (Model #3951-083) on the Cotton heat setting for approximately 3 seconds.

### Example 4

Comparative Example 1 was repeated except that the film attached to RC was ML-B1. ML-B1 was attached to RC by a tie-layer of 3M scotch weld Epoxy adhesive DP 100 Plus.

### Example 5

Example 4 was repeated except that the film attached to RC by means of the tie-layer was ML-B2.

### Example 6

Example 1 was repeated except that the film attached to RC was FB1. FB1 was attached to RC by Sunbeam Iron (Model #3951-083) on the Cotton heat setting for approximately 3 seconds.

### Example 7

Example 1 was repeated except that the film attached to RC was FF4. FF4 was attached to RC by fingertip pressure.

The wear rate (WR) of the three pre-conditioned wheels at Day 0 was 3026, 3403, and 3329 mm3/min. The WR of each Comparative Example and Example as a function of days held at the conditions specified is in Table 2.

TABLE 2

| | | WR after | WR after | WR after | WR after |
|---|---|---|---|---|---|
| Sample | Package | 7 days | 14 days | 21 days | 42 days |
| Comp. | No packaging, 5% RH/ambient | 3206.58 | 3676.05 | 4267.09 | 3671.89 |
| Ex. A | temperature | | | | |
| Comp. | No packaging, 90% RH/90 F. | 4939.67 | 6800.64 | 7690.10 | 7533.35 |
| Ex. B | | | | | |
| Comp. | Standard Foil Bag, Heat Sealed, | 3404.73 | 3757.76 | 3483.99 | 4294.64 |
| Ex. C | 90% RH/90 F. | | | | |
| Comp. | CFlex Paper Pouch, Heat Sealed, | 4618.81 | 5928.41 | 7301.30 | 8864.89 |
| Ex. D | 90% RH/90 F. | | | | |
| Comp. | CFlex Al 38 Pouch, Heat Sealed, | 3682.61 | 3943.17 | 5974.12 | 5605.09 |
| Ex. E | 90% RH/90 F. | | | | |
| Comp. | CFlex PE film Pouch, Heat | 4609.04 | 4332.73 | 5524.29 | 7281.49 |
| Ex. F | Sealed, 90% RH/90 F. | | | | |
| Exam- | ACCURA 25 Rigid Container, | 5009.63 | 5289.46 | 5988.71 | 6030.70 |
| ple 1 | CFlex PE film, Heat Sealed, | | | | |
| | 90% RH/90 F. | | | | |
| Exam- | ACCURA 25 Rigid Container, | 4490.61 | 5276.42 | 7018.06 | 7934.37 |
| ple 2 | CFlex paper, Heat Sealed, | | | | |
| | 90% RH/90 F. | | | | |
| Exam- | ACCURA 25 Rigid Container, | 4226.33 | 3562.20 | 4587.69 | 8033.93 |
| ple 3 | CFlex Al Foil, Heat Sealed, | | | | |
| | 90% RH/90 F. | | | | |
| Exam- | ACCURA 25 Rigid Container, | 3247.43 | 3767.45 | 3607.45 | 4035.95 |
| ple 4 | CRPL Metal Film, Tie-layer | | | | |
| | Sealed, 90% RH/90 F. | | | | |
| Exam- | ACCURA 25 Rigid Container, | 3658.26 | 3796.13 | 5241.19 | 6084.68 |
| ple 5 | CRPL Transparent Film, Tie- | | | | |
| | layer sealed, 90% RH/90 F. | | | | |
| Exam- | ACCURA 25 Rigid Container, | 3762.05 | 4390.84 | 5562.37 | 7047.17 |
| ple 6 | Standard Foil Bag, Heat Sealed, | | | | |
| | 90% RH/90 F. | | | | |
| Exam- | ACCURA 25 Rigid Container, | 4159.86 | 5207.88 | 6987.20 | 7162.12 |
| ple 7 | Press N Seal, 90% RH/90 F. | | | | |

1. A packaging system for abrasive articles, the packaging system comprising:
a container portion sized to receive the abrasive articles;
a lid portion that removably couples to the container portion;
a sealing feature between the container portion and lid portion;
a rechargeable moisture control feature, housed within the packaging system, and wherein the rechargeable moisture control feature removes moisture from an atmosphere within the packaging system; and
a moisture indicator that indicates whether moisture is present within the container portion.

2. The packaging system of claim 1, wherein the container portion or the lid portion have a transparent area such that the moisture indicator is visible.

3-6. (canceled)

7. The packaging system of claim 1, wherein the rechargeable moisture feature removes moisture through adsorption.

8. The packaging system of claim 1, wherein the rechargeable moisture feature removes moisture by absorption.

9. The packaging system of claim 1, wherein the moisture indicator indicates whether moisture is present above a threshold concentration.

10. (canceled)

11. The packaging system of claim 9, wherein the moisture indicator is a color change of the moisture control feature, wherein the color change indicates that the moisture control feature has reached an adsorption loading threshold.

12. The packaging system of claim 9, wherein the moisture indicator is a conductivity indication, indicating that moisture is present at a concentration sufficient for the moisture control feature to conduct electricity.

13-15. (canceled)

16. The packaging system of claim 1, wherein the sealing feature is a film.

17. The packaging system of claim 1, wherein the sealing feature is an adhesive.

18. The packaging system of claim 1, wherein the sealing feature is integral to the container portion or the lid portion and comprises a closure mechanism.

19. (canceled)

20. The packaging system of claim 1, and further comprising a shelf life indicator.

21. The packaging system of claim 1, and further comprising:
a sealing feature, positioned on the lid portion, wherein the sealing feature comprises an access port for a vacuum pump; and
wherein the sealing feature is configured to maintain a pressure differential across the lid portion or across the container portion.

22. (canceled)

23. A method of reducing moisture in an abrasive article during transportation or storage, the method comprising:
providing a housing with a shape that receives an abrasive article, wherein the housing has a transparent portion;
providing a moisture control feature, within the packaging housing, wherein the moisture control feature is removably coupled to an interior of the housing;
providing a seal that reduces moisture transmission into the housing; and
providing a moisture indication that indicates that the moisture control feature has reached a moisture collection capacity.

24. (canceled)

25. (canceled)

26. The method of claim 23, wherein the housing comprises a lid portion and a container portion.

27. (canceled)

28. (canceled)

29. The method of claim 26, wherein the lid portion and the container portion are bio-based, recyclable, reusable or compostable.

30. (canceled)

31. The method of claim 23, wherein the moisture control feature is rechargeable.

32. (canceled)

33. (canceled)

34. The method of claim 23, wherein the seal is a film seal, an adhesive seal, a flange, or a compressible component.

35. The method of claim 23, and further comprising:
flushing the housing with argon or nitrogen gas.

36. (canceled)

37. The method of claim 23, and further comprising:
evacuating the housing, wherein evacuating comprises coupling a vacuum pump to a vacuum sealing feature, and actuating the vacuum pump.

38. (canceled)

39. (canceled)

40. An abrasive article dispensing system comprising:
a housing comprising:
a container portion; and
a dispenser comprising:
a dispenser coupling feature that releasably couples to the container coupling feature to removably couple the housing to the dispenser;
a dispensing mechanism that receives a single abrasive article from the housing container; and
a trigger that, when initiated, causes the dispensing mechanism to release the abrasive article from the housing.
